(19) United States
(12) Patent Application Publication
(10) Pub. No.: US 2017/0019203 A1
(43) Pub. Date: Jan. 19, 2017

(54) OPTICAL RECEIVER AND METHOD FOR UPDATING TAP COEFFICIENT OF DIGITAL FILTER

(71) Applicant: FUJITSU LIMITED, Kawasaki-shi (JP)

(72) Inventors: Soleim ASM, Kawasaki (JP); Taku Saito, Kawasaki (JP)

(73) Assignee: FUJITSU LIMITED, Kawasaki-shi (JP)

(21) Appl. No.: 15/193,501

(22) Filed: Jun. 27, 2016

(30) Foreign Application Priority Data
Jul. 16, 2015 (JP) 2015-141918

(51) Int. Cl. H04J 14/02; H04B 10/61; H04B 1/00; H04B 10/25

(52) U.S. Cl. CPC H04J 14/02; H04B 10/25; H04B 10/61; H04B 1/0017

(57) ABSTRACT

An optical receiver, that receives wavelength division multiplexed light including a target channel, includes: a receiver configured to generate an electric signal from input light that includes the target channel; an A/D converter configured to convert the electric signal generated by the receiver into a digital signal; a digital filter configured to filter the digital signal output from the A/D converter with a first frequency characteristic; and a filter controller configured to control a frequency characteristic of the digital filter. The filter controller changes the frequency characteristic of the digital filter from the first frequency characteristic to a second frequency characteristic in stages when a filter control instruction that specifies the second frequency characteristic is given to the filter controller.

### CROSS-REFERENCE TO RELATED APPLICATION

This application is based upon and claims the benefit of priority of the prior Japanese Patent Application No. 2015-141918, filed on Jul. 16, 2015, the entire contents of which are incorporated herein by reference.

### FIELD

The embodiments discussed herein are related to an optical receiver that receives a wavelength division multiplexed optical signal and a method for updating tap coefficients of a digital filter that is used in the optical receiver.

### BACKGROUND

As a technology for realizing an increase in the capacity or speed of a communication system, wavelength division multiplexing (WDM) has been widespread. WDM transmits data using a plurality of different wavelengths. That is, in WDM, a plurality of wavelength channels are multiplexed. For example, a WDM transmission system in which 88 wavelength channels are multiplexed is put into practical use. In addition, in a transmission system in which DP-QPSK (dual polarization quadrature phase shift keying) modulation scheme and a digital coherent signal processing technology is adopted, the transmission rate of one wavelength channel is sped up to 100 Gbps. In this case, it is possible to realize a WDM transmission system of 8.8 Tbps.

As a technology for further increasing the capacity of the WDM transmission system, a technology is proposed which narrows an spacing between wavelength channels. In recent years, a scheme is proposed in which wavelength channels are arranged at spacing less than 50 GHz.

However, if the spacing between wavelength channels is narrow, interference (that is, crosstalk) is likely to occur between wavelength channels. Crosstalk deteriorates the quality of each wavelength channel. Therefore, an optical receiver of the WDN transmission system includes a filter for extracting an optical signal of a desired wavelength channel from a WDM optical signal. In a digital coherent receiver, an optical signal of a desired wavelength channel is extracted from a WDM optical signal using local light. In recent years, a technology is proposed which suppresses an influence from an adjacent channel using a digital filter such as an FIR filter.

As a related technology, a wavelength division multiplexing system is proposed which realizes a high spectrum efficiency over a long distance using Nyquist WDM (for example, Japanese Laid-open Patent Publication No. 2013-183455). In addition, a WDM transmission device is proposed that receives a wavelength multiplexed optical signal in which optical signals are arranged at high density and that performs adding/dropping, switching, and routing for each wavelength (for example Japanese Laid-open Patent Publication No. 2013-106187).

It is preferable that the bandwidth of a filter for extracting an optical signal of a target wavelength channel from a WDM optical signal be appropriately controlled according to an spacing between the target wavelength channel and the adjacent wavelength channel. That is, if the bandwidth of the filter is too wide, crosstalk is not sufficiently suppressed.

In contrast, if the bandwidth of the filter is too narrow, since some components of the signal to be extracted are removed, the quality of a received signal may deteriorate.

However, in recent years, a WDM transmission system is proposed which can change a spacing between wavelength channels during communication. In addition, in an OADM (optical add drop multiplexer) node, a signal may be added in the adjacent channel or a signal may be removed from the adjacent channel. In these cases, it is preferable that the bandwidth of the filter be controlled according to a change in the spacing between the target wavelength channel and the adjacent wavelength channel or according to a change in the state of the adjacent channel.

However, when the bandwidth of the filter for extracting the optical signal of the target wavelength channel from the WDM optical signal changes, the quality of the received signal may temporarily deteriorate. For example, in a case in which an adaptive equalizer which equalizes a received signal is provided on the output side of the filter, when the bandwidth of the filter changes, the adaptive equalizer may not be able to sufficiently equalize the received signal temporarily. When the received signal is not sufficiently equalized, a bit error rate of data which is recivered from the signal may be high.

### SUMMARY

According to an aspect of the invention, an optical receiver, that receives wavelength division multiplexed light including a target channel, includes: a receiver configured to generate an electric signal from input light that includes the target channel; an A/D converter configured to convert the electric signal generated by the receiver into a digital signal; a digital filter configured to filter the digital signal output from the A/D converter with a first frequency characteristic; and a filter controller configured to control a frequency characteristic of the digital filter. The filter controller changes the frequency characteristic of the digital filter from the first frequency characteristic to a second frequency characteristic in stages when a filter control instruction that specifies the second frequency characteristic is given to the filter controller.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an optical transmission system.

FIG. 2 illustrates an example of the configuration of an optical transmitter.

FIG. 3 illustrates an example of a transponder.

FIGS. 4A and 4B illustrate examples of a WDM optical signal.

FIG. 5 illustrates an example of an optical receiver circuit.

FIGS. 6A-6C are diagrams explaining crosstalk between wavelength channels.

FIGS. 7A and 7B illustrate examples of the function of a digital signal processor.

FIG. 8 illustrates an example of a digital filter.

FIGS. 9A and 9B illustrate tap coefficients and frequency characteristics of the digital filter.

FIGS. 10A-10D illustrate examples of filter bandwidth control.

FIGS. 11A and 11B illustrate an example of the configuration and operation of a sampling phase detector.

FIG. 12 illustrates an example of the configuration of an adaptive equalizer.

FIGS. 13A-13C illustrate an example of the operation of the adaptive equalizer.

FIGS. 14A and 14B illustrate examples of updating of tap coefficients and updating of a cutoff frequency.

FIG. 15 illustrates an example of an optical receiver circuit according to a first embodiment.

FIG. 16 illustrates an example of a coefficient table.

FIG. 17 is a flowchart illustrating an example of a coefficient updating method according to the first embodiment.

FIG. 18 illustrates an example of an optical receiver circuit according to a second embodiment.

FIG. 19 is a flowchart illustrating an example of a coefficient updating method according to the second embodiment.

FIG. 20 is a flowchart illustrating an example of a coefficient updating method according to a third embodiment.

FIGS. 21A-21C illustrate an example of an optical receiver circuit according to another embodiment.

### DESCRIPTION OF EMBODIMENTS

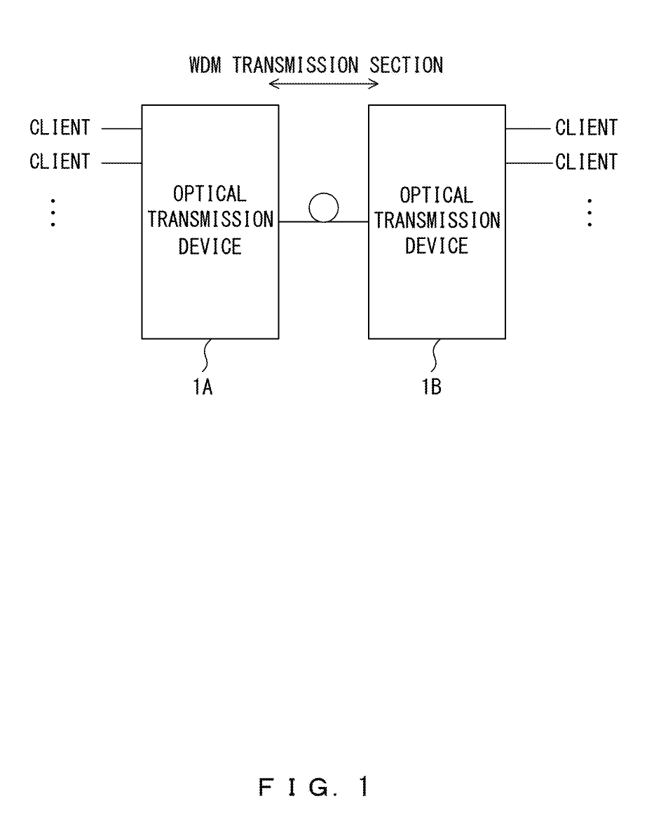

FIG. 1 illustrates an example of the optical transmission system according to an embodiment of the present invention. The optical transmission system includes a plurality of optical transmission devices. In the example illustrated in FIG. 1, the optical transmission system includes optical transmission deveces 1A and 1B. The optical transmission deveces 1A and 1B are optically connected by an optical transmission path. Note that on the optical transmission path between the optical transmission deveces 1A and 1B, one or a plurality of optical amplifiers may be provided.

Each of the optical transmission deveces 1A and 1B can accommodate one or a plurality of clients. The client may be accommodated in the optical transmission devece 1A or 1B via a router, etc.

The optical transmission devece 1A multiplexes data signals which are received from a plurality of clients and generates a WDM optical signal. Then, the optical transmission devece 1A transmits the WDM optical signal to the optical transmission devece 1B via the optical transmission path. The optical transmission devece 1B splits the WDM optical signal which has been received from the optical transmission devece 1A and recovers each data signal. Then, the optical transmission devece 1B guides the data signals to respective clients. Note that in the optical transmission system illustrated in FIG. 1, it is also possible to transmit a WDM optical signal from the optical transmission devece 1B to the optical transmission devece 1A.

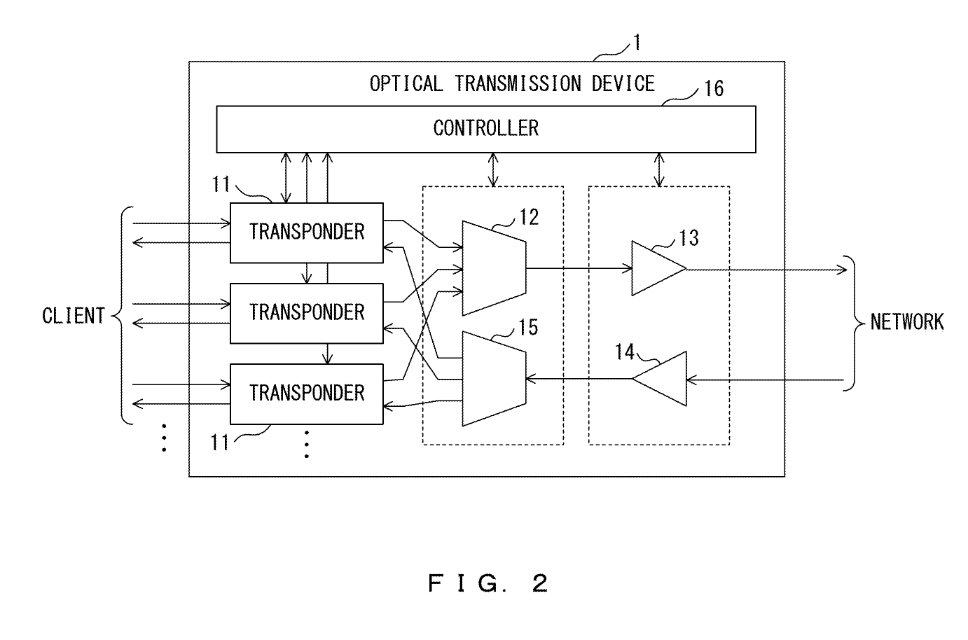

FIG. 2 illustrates an example of the configuration of the optical transmission devece. As illustrated in FIG. 2, the optical transmission devece 1 includes a plurality of transponders 11, an optical combiner 12, optical amplifiers 13 and 14, an optical branching device 15, and a controller 16. Note that the optical transmission devece 1 illustrated in FIG. 2 corresponds to the optical transmission devece 1A or 1B in the optical transmission system illustrated in FIG. 1. In addition, the optical transmission devece 1 may include other circuit elements which are not illustrated in FIG. 2.

The transponder 11 generates a modulated optical signal which transmits data received from a client. The wavelength of the modulated optical signal is controlled by the controller 16. At that time, the controller 16 controls each transponder 11 so that wavelengths of a plurality of modulated optical signals are different from each other. In addition, the transponder 11 recovers data from the modulated optical signal received from the network. The recovered data is guided to a corresponding client.

The optical combiner 12 combines the plurality of modulated optical signals that are generated by the plurality of transponders 11 to generate a WDM optical signal. The optical amplifier 13 amplifies the WDM optical signal that is output from the optical combiner 12. The optical amplifier 14 amplifies a WDM optical signal that is received via a network. The optical branching device 15 branches the WDM optical signal that is output from the optical amplifier 14 and guides the branched optical signal to transponders 11. Each of the branched optical signals may include a plurality of wavelengths.

The controller 16 controls the operation of the optical transmission devece 1. For example, the controller 16 can control the wavelength that each transponder 11 processes. In addition, the controller 16 may control the operation of the optical transmission devece 1, for example, according to an instruction which is received from a network management system that manages the optical transmission system. Note that the controller 16 is realized, for example, by a processor system which includes a processor and a memory. In this case, the processor system controls the operation of the optical transmission devece 1 by executing a program provided to the processor system.

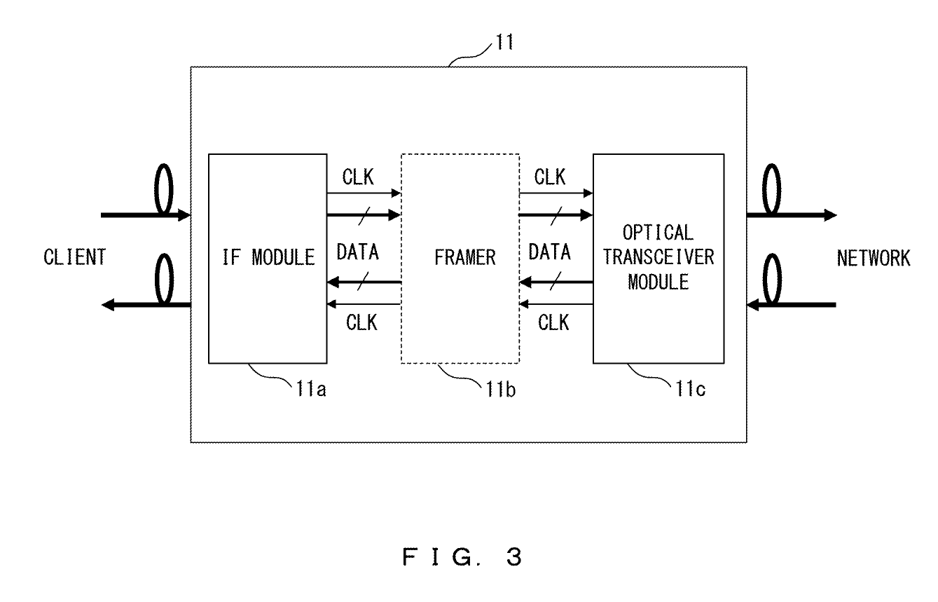

FIG. 3 illustrates an example of the transponder 11 which is provided in the optical transmission devece 1. As illustrated in FIG. 3, the transponder 11 includes an IF module 11a, a framer 11b, and an optical transceiver module 11c. Note that the transponder 11 may include other circuit elements that are not illustrated in FIG. 3.

The IF module 11a accommodates one or a plurality of client lines. The client line may transmit an optical signal or an electric signal. The framer 11b performs a frame process. For example, the framer 11b may perform format conversion between SONET (synchronous optical network) or GbE (gigabit Ethernet) which is used on the client side and OTN (optical transport network) which is used on the network side. Furthermore, the framer 11b may perform error correction. The optical transceiver module 11c generates a modulated optical signal which transmits a frame that is generated by the framer 11b. In addition, the optical transceiver module 11c demodulates the received modulated optical signal and guides the recovered signal to the framer 11b.

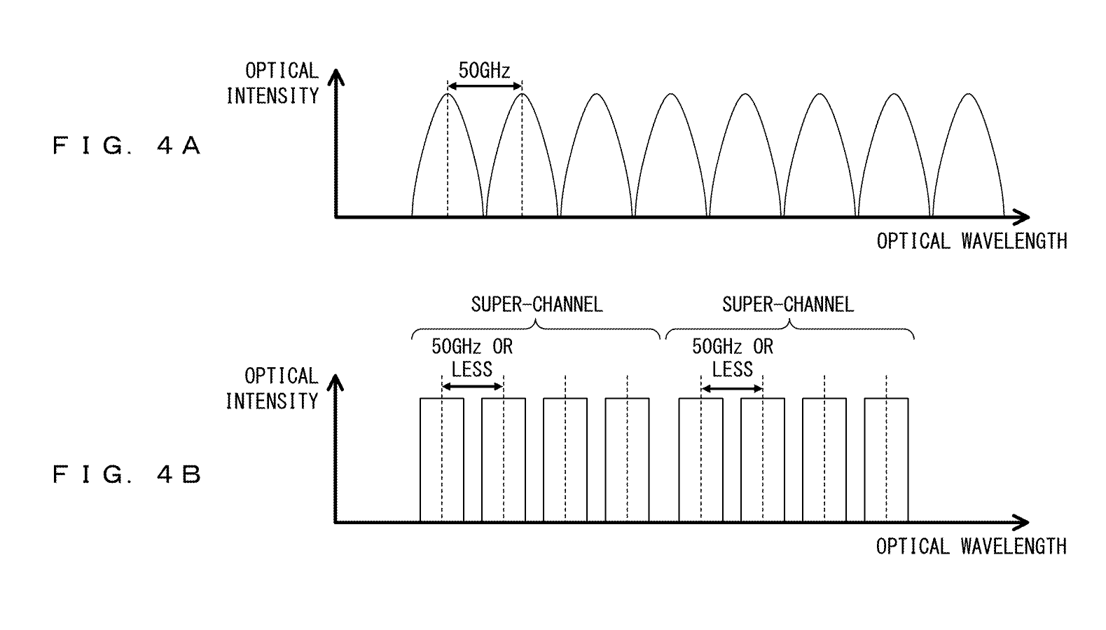

FIGS. 4A and 4B illustrate examples of the WDM optical signal that is transmitted in the optical transmission system. In the example illustrated in FIG. 4A, a plurality of wavelength channels are arranged at 50 GHz spacing. Note that a WDM transmission system in which wavelength channels are arranged at 50 GHz spacing is put into practical use.

FIG. 4B illustrates an example of the WDM optical signal that includes a super-channel signal. A super-channel includes a plurality of wavelength channels whose transmission routes are the same. The plurality of wavelength channels that belong to the super-channel may be arranged at spacing less than 50 GHz. For example, the plurality of wavelength channels that belong to the super-channel may be arranged at spacing of 37.5 GHz. Therefore, it is possible to increase the capacity of the WDM optical signal using a super-channel technology. Note that in the super-channel, the spectrum of the optical signal of each wavelength channel is shaped so that interference (crosstalk) between wavelength channels is suppressed. The spectrum is shaped for example, by a raised-cosine filter or a Nyquist filter.

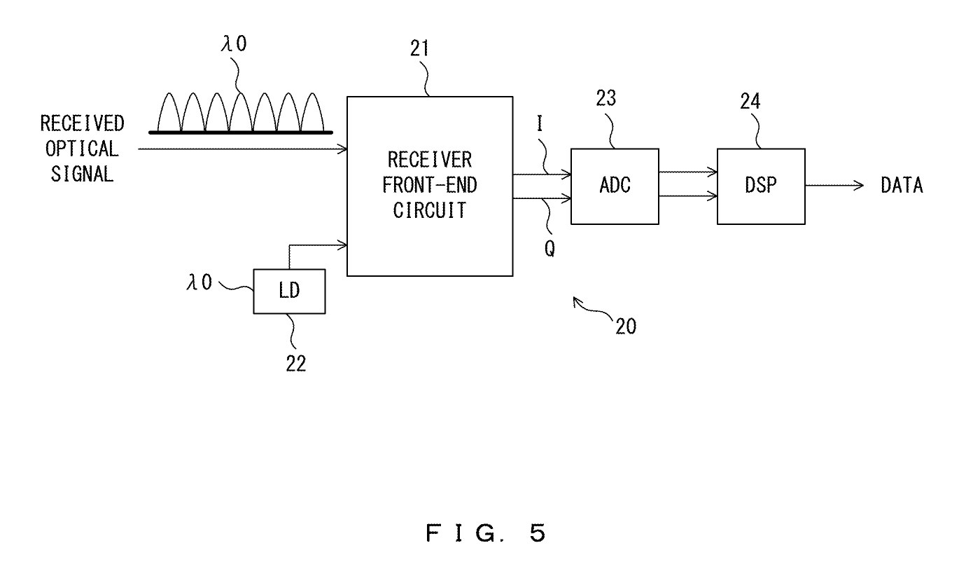

FIG. 5 illustrates an example of the optical receiver circuit. The optical receiver circuit 20 illustrated in FIG. 5 is provided, for example, in the optical transceiver module 11c of each transponder 11. As illustrated in FIG. 5, the optical receiver circuit 20 includes a receiver front-end circuit 21, a local oscillation light source 22, an A/D (Analog-to-Digital) converter (ADC) 23, and a digital signal processor (DSP) 24.

A received optical signal is guided from the optical branching device 15 illustrated in FIG. 2 to the optical receiver circuit 20. Here, the optical branching device 15 branches the WDM optical signal. That is, the optical receiver circuit 20 receives an optical signal of a target channel. However, the optical signal may include adjacent channels.

The receiver front-end circuit 21 generates an electric signal (electric field information signal) which indicates the amplitude and phase of the received optical signal by mixing the received optical signal and local oscillation light which is generated by the local oscillation light source 22. Note that wavelength λ0 of the local oscillation light is nearly the same as the wavelength of the target channel. In addition, the electric field information signal is composed of the I component signal and Q component signal in a baseband. The A/D converter 23 converts an electric signal (electric field information signal) that is output from the receiver front-end circuit 21 into a digital signal. Then, the digital signal processor 24 recovers data from the digital signal that is output from the A/D converter 23.

Note that when the spacing between the wavelength channels of the received optical signal is narrow, the optical branching device 15 may not be able to extract only the optical signal of the target channel. In addition, depending on the configuration of the optical transmission devece, optical signals of a plurality of wavelength channels that are adjacent to each other may be guided to the optical receiver circuit 20 as illustrated in FIG. 5. Therefore, the digital electric field information signal that is input to the digital signal processor 24 may include a crosstalk component.

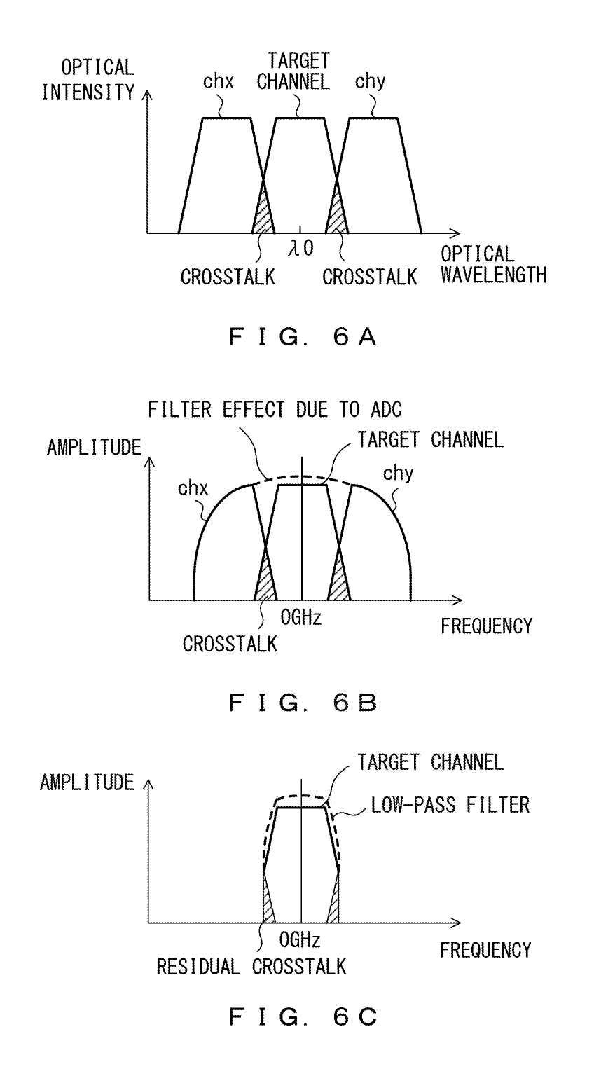

FIGS. 6A-6C are diagrams explaining crosstalk between wavelength channels. In the following description, as illustrated in FIG. 6A, it is assumed that optical signals of target channel ch0 and adjacent channels chx and chy are input to the optical receiver circuit 20. Target channel ch0 and adjacent channels chx and chy belong to, for example, one super-channel. In this example, crosstalk occurs between target channel ch0 and adjacent channel chx and between target channel ch0 and adjacent channel chy. Note that FIG. 6A illustrates the spectrum in an optical domain.

FIG. 6B illustrates a signal input to the digital signal processor 24 illustrated in FIG. 5. Here, as described above, the received optical signal is mixed with the local oscillation light in the receiver front-end circuit 21. Therefore, the signal components of the target channel appear on a baseband. In addition, in the A/D converter 23, high-frequency components are substantially removed. However, crosstalk components remain also in the signal input to the digital signal processor 24.

Therefore, as illustrated in FIG. 6C, the digital signal processor 24 removes signal components of the adjacent channels using a low-pass filter. The low-pass filter is implemented, for example, by a digital filter such as an FIR filter. However, it is difficult to completely remove crosstalk components even if the signal components of the adjacent channels are removed using the low-pass filter.

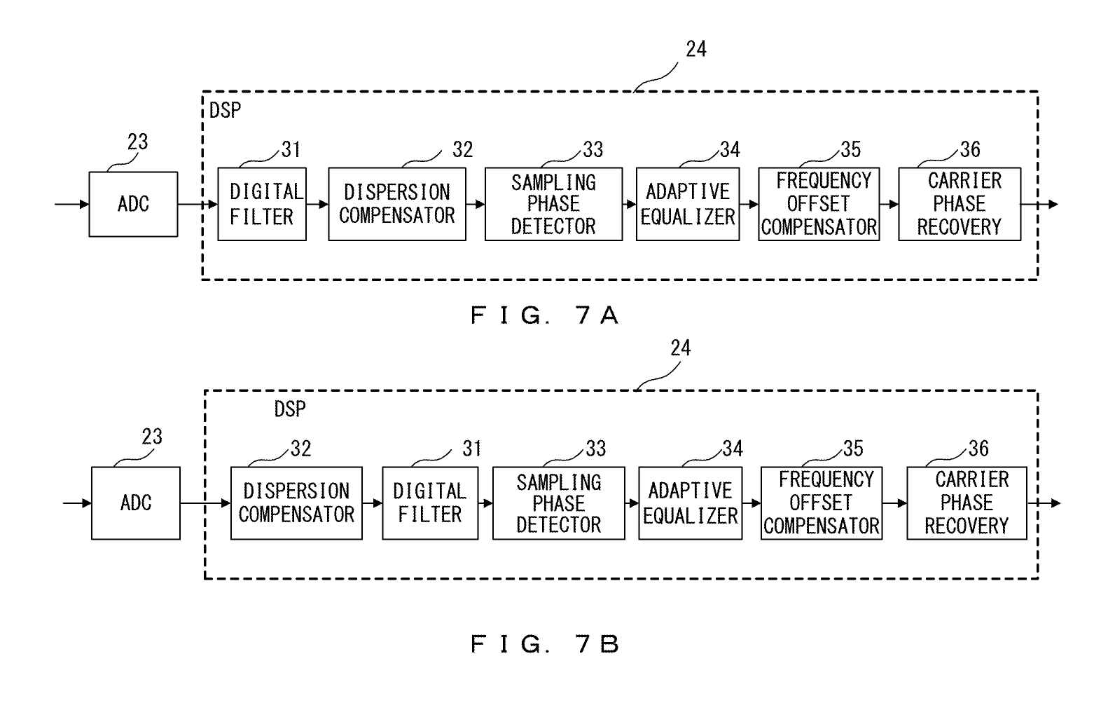

FIGS. 7A and 7B illustrate examples of the function of the digital signal processor 24. The digital signal processor 24 includes a digital filter 31, a dispersion compensator 32, a sampling phase detector 33, an adaptive equalizer 34, a frequency offset compensator 35, and a carrier phase recovery 36. Note that the digital signal processor 24 may include other functions that are not illustrated in FIGS. 7A and 7B. For example, the digital signal processor 24 may be shared by the optical receiver circuit and an optical transmitter circuit in the optical transceiver module 11c. That is, the digital signal processor 24 may include a function for generating a transmission signal, a function for performing pre-equalization, etc. The dispersion compensator 32 may be provided on the output side of the digital filter 31 as illustrated in FIG. 7A, or may be provided on the input side of the digital filter 31 as illustrated in FIG. 7B. In the following description, it is assumed that the dispersion compensator 32 is provided on the output side of the digital filter 31.

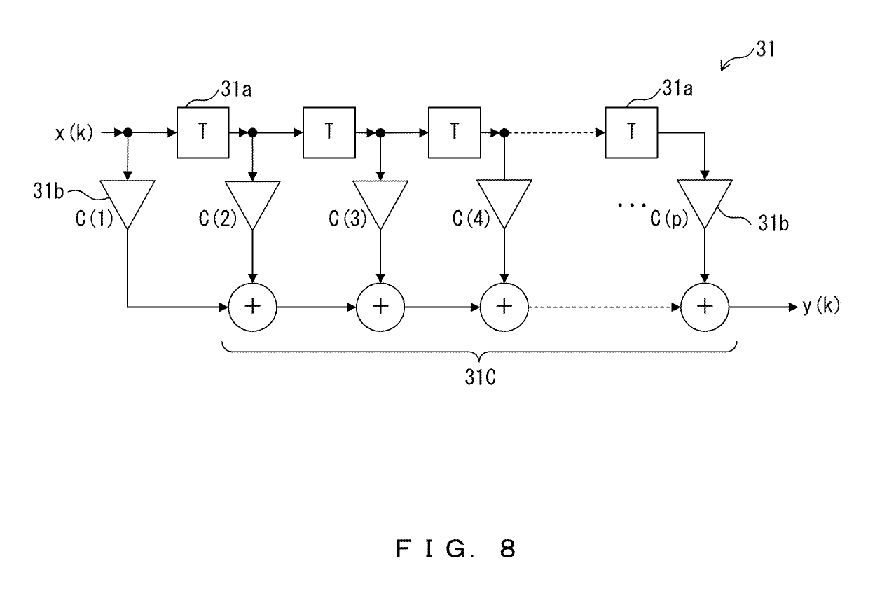

The digital filter 31 passes low-frequency components of an input signal and removes high-frequency components of the input signal. That is, the digital filter 31 functions as a low-pass filter. In this example, the digital filter 31 is implemented by the FIR filter illustrated in FIG. 8. In this case, the digital filter 31 includes a plurality of delay elements 31a, a plurality of multipliers 31b, and an adding circuit 31c. Each delay element 31a delays input signal x by one sampling time. Each multiplier 31b multiplies input signal x by corresponding tap coefficient C. That is, p consecutive samples are multiplied by tap coefficients C(1) to C(p), respectively. The adding circuit 31c outputs the sum of the multiplication results.

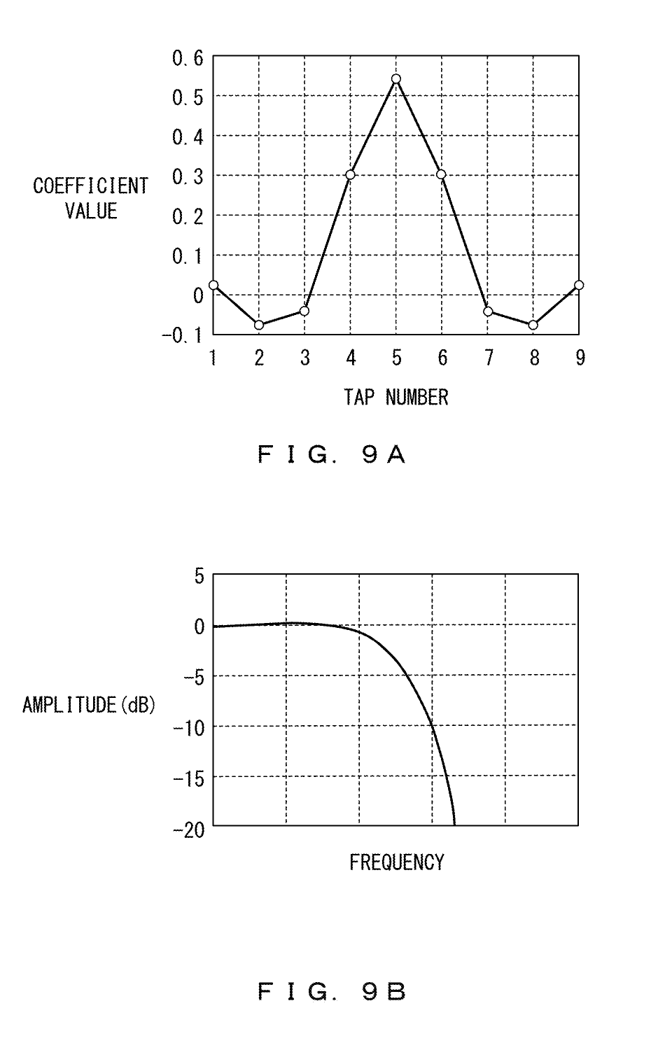

The digital filter 31 can operate as a low-pass filter by appropriately determining tap coefficients C(1) to C(p). FIG. 9A illustrates an example of tap coefficients for realizing a low-pass filter. In addition, FIG. 9B illustrates a frequency characteristic of the digital filter 31 to which the tap coefficients illustrated in FIG. 9A are given. The cutoff frequency of the low-pass filter is controlled by tap coefficients.

The dispersion compensator 32 compensates for dispersion which is added to an optical signal in the optical transmission path. The sampling phase detector 33 includes a function for adjusting the sampling timing of the A/D converter 23. The adaptive equalizer 34 equalizes the bandwidth (here, spectrum) of a received signal. In addition, when the received optical signal is a polarization multiplexed optical signal, the adaptive equalizer 34 can also perform polarization demultiplexing and compensate for polarization mode dispersion. The frequency offset compensator 35 compensates for the difference between the carrier frequency of the received optical signal and the frequency of local oscillation light. The carrier phase recovery 36 recovers the phase of the carrier of the received optical signal. Note that although not illustrated, the digital signal processor 24 can recover data from a signal whose frequency offset is compensated for and whose phase is recovered.

As described, the digital signal processor 24 includes the digital filter 31, which operates as a low-pass filter, and removes the high-frequency components of the received signal. As a result, an influence due to crosstalk is suppressed and a bit error rate is improved.

However, in recent years, a WDM transmission system is proposed which can change a spacing between wavelength channels during communication. In addition, in an optical add/drop node, when an optical signal of a specified wavelength is dropped from a WDM optical signal or an optical signal is added to the WDM optical signal, the spacing between the target channel and the adjacent channel may change. Therefore, in these cases, it is preferable that the frequency characteristic of the filter (here, the cutoff frequency of the low-pass filter) be controlled according to a change in the spacing between the target channel and the adjacent channel.

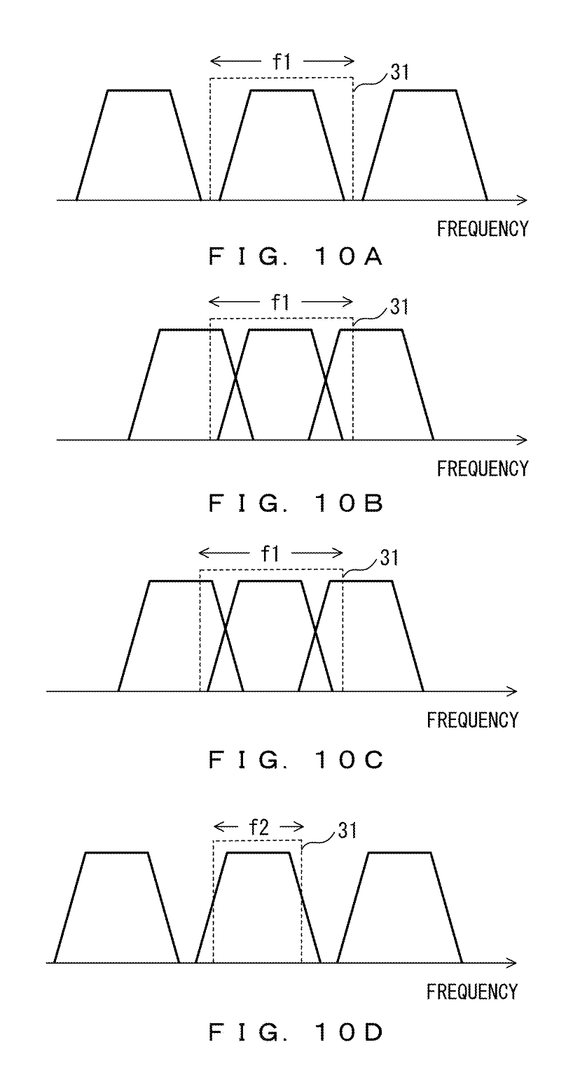

FIGS. 10A-10D illustrate examples of controlling a filter bandwidth according to the spacing between wavelength channels. Note that FIGS. 10A-10D each schematically illustrate a signal input to the digital signal processor 24 and a passband of the digital filter 31.

In the example illustrated in FIG. 10A, wavelength channels are arranged at specified frequency spacing. The digital filter 31 is controlled so as to pass the signal components of the target channel and to cut off the signal components of the adjacent channel. “f1” is equivalent to the cutoff frequency of the digital filter 31, which operates as a low-pass filter.

It is assumed that when the digital filter 31 operates at cutoff frequency f1, the spacing between wavelength channels becomes narrow as illustrated in FIG. 10B. In this case, not only the signal components of the target channel but also some of the signal components of the adjacent channels pass through the digital filter 31. Therefore, in order to remove the signal components of the adjacent channels, it is preferable that the passband of the digital filter 31 be narrowed (that is, the cutoff frequency of the digital filter 31 be lowered) as illustrated in FIG. 10C. Note that in FIGS. 10B and 10C, the cutoff frequency of the digital filter 31 is controlled from f1 to f2.

It is assumed that when the digital filter 31 operates at cutoff frequency f2, the spacing between wavelength channels becomes wide as illustrated in FIG. 10D. In this case, some of the signal components of the target channel are removed by the digital filter 31 and the quality of the signal deteriorates. Therefore, in order to improve the quality of the signal of the target channel, it is preferable that the passband of the digital filter 31 be widened (that is, the cutoff frequency of the digital filter 31 be increased) as illustrated in FIG. 10A.

Note that in the examples illustrated in FIGS. 10A-10D, the filter bandwidth is controlled according to the spacing between wavelength channels; however, the filter bandwidth may be controlled according to another factor. For example, the passband of the filter may be widened when the signal is stopped or dropped in the channel adjacent to the target channel. In addition, the passband of the filter may be narrowed when a signal is added in the channel adjacent to the target channel.

As described, in order to improve the reception quality of the target channel, the optical receiver circuit 20, which receives a WDM optical signal, can control the frequency characteristic of the digital filter 31 according to the spacing between wavelength channels, etc. For example, when the optical receiver circuit 20 receives a message which instructs a change in the spacing between wavelength channels from the network management system, the optical receiver circuit 20 controls the frequency characteristic of the digital filter 31 according to the message.

However, when the frequency characteristic of the digital filter 31 for extracting the optical signal of the target channel changes, the quality of the received signal may temporarily deteriorate. That is, when the frequency characteristic of the digital filter 31 rapidly changes, the signal output from the digital filter 31 greatly changes. When the signal output from the digital filter 31 greatly changes, the sampling phase detector 33 and/or the adaptive equalizer 34 may not be able to follow the change in the signal. Specifically, the sampling timing that is controlled by the sampling phase detector 33 may be shifted. In addition, the adaptive equalizer 34 may not be able to correctly equalize the received signal.

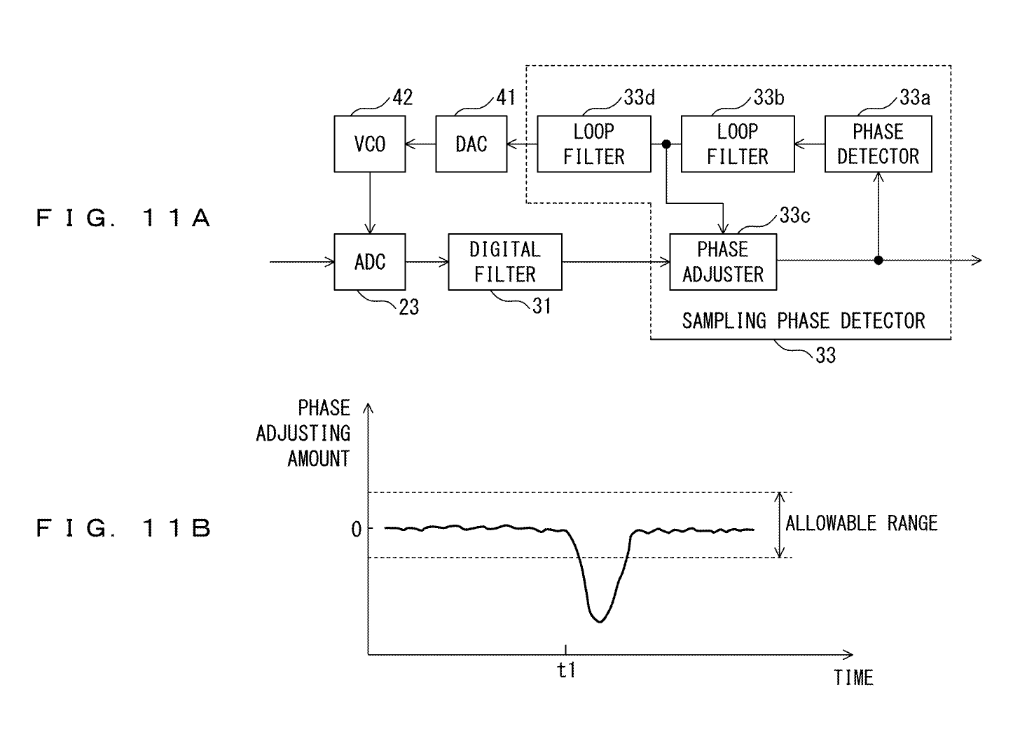

FIGS. 11A and 11B illustrate an example of the configuration and operation of the sampling phase detector 33. As illustrated in FIG. 11A, the sampling phase detector 33 includes a phase detector 33a, a loop filter 33b, a phase adjuster 33c, and a loop filter 33d. Note that the sampling phase detector 33 may include other circuit elements.

The phase detector 33a detects the sampling phase of the A/D converter 23. For example, the phase detector 33a outputs phase shift information indicating whether a sampling clock is ahead or behind with respect to the received signal. The loop filter 33b averages the phase shift information which is output from the phase detector 33a and calculates a sampling phase adjusting amount. The phase adjuster 33c adjusts the sampling phase according to the sampling phase adjusting amount that is calculated by the loop filter 33b. The loop filter 33d further averages the sampling phase adjusting amount that is calculated by the loop filter 33b to calculate a sampling frequency control value.

AD/A (Digital-to-Analog) converter (DAC) 41 converts the sampling frequency control value into an analog signal to generate a control voltage. A voltage control oscillator (VCO) 42 generates a clock signal of a frequency corresponding to the control voltage. The clock signal is used as the sampling clock of the A/D converter 23.

When the optical receiver circuit 20 stably operates, the phase adjusting amount (for example, the sampling phase adjusting amount that is calculated by the loop filter 33b) is nearly zero as illustrated in FIG. 11B. Here, when the frequency characteristic of the digital filter 31 changes, the signal input to the sampling phase detector 33 changes. In FIG. 11B, at time point t1, the frequency characteristic of the digital filter 31 changes. Then, the phase adjusting amount temporality changes. If the signal input to the sampling chase detector 33 greatly changes due to the change in the frequency characteristic of the digital filter 31, the phase adjusting amount may deviate from a specified allowable range. The allowable range is set, for example, corresponding to the bit error rate that the optical transmission system ensures.

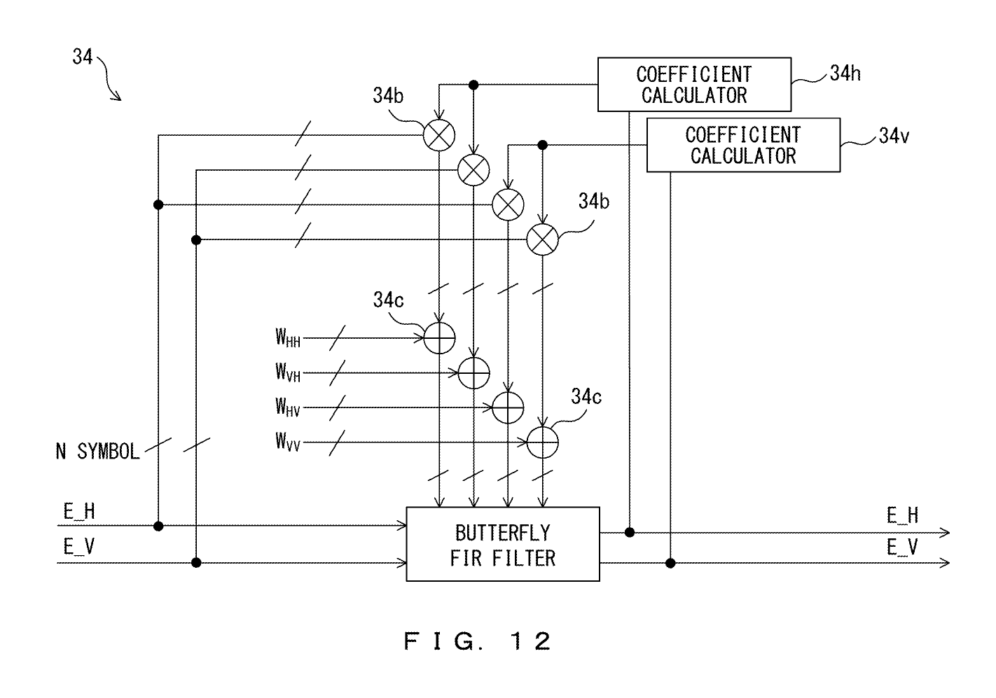

FIG. 12 illustrates an example of the configuration of the optical equalizer 34. In this example, it is assumed that the optical receiver circuit 20 receives a polarization multiplexed optical signal. In addition, it is assumed that the adaptive equalizer 34 executes signal processing of a plurality of samples in parallel. In this configuration, the clock frequency of the adaptive equalizer 34 lowers and power consumption may be reduced.

As illustrated in FIG. 12, the adaptive equalizer 34 includes a butterfly FIR filter 43a, coefficient calculators 34h and 34v, multipliers 34b, and adders 34c. The butterfly FIR filter 34a performs polarization division and equalizes the input signal according to tap coefficients given to the filter. The coefficient calculators 34h and 34v respectively calculate target coefficients using, for example, the following formulas.

34h: μ*(γ−|Eₕ(0)|²)*Eₕ(0)

34v: μ*(γ−|Eᵥ(0)|²)*Eᵥ(0)

μ is a step-size parameter for smoothly changing a tap coefficient which is given to the butterfly FIR filter 34a, and satisfies 0<μ<1.

The multiplier 34b multiplies the input signal by the coefficients calculated by the coefficient calculator 34h or 34v. The adder 34c corrects the tap coefficients by adding polarization division parameter W to the signal output from corresponding multiplier 34b. The butterfly FIR filter 34a executes equalization (and polarization demultiplexing and polarization mode dispersion compensation) of the received signal using the corrected tap coefficients.

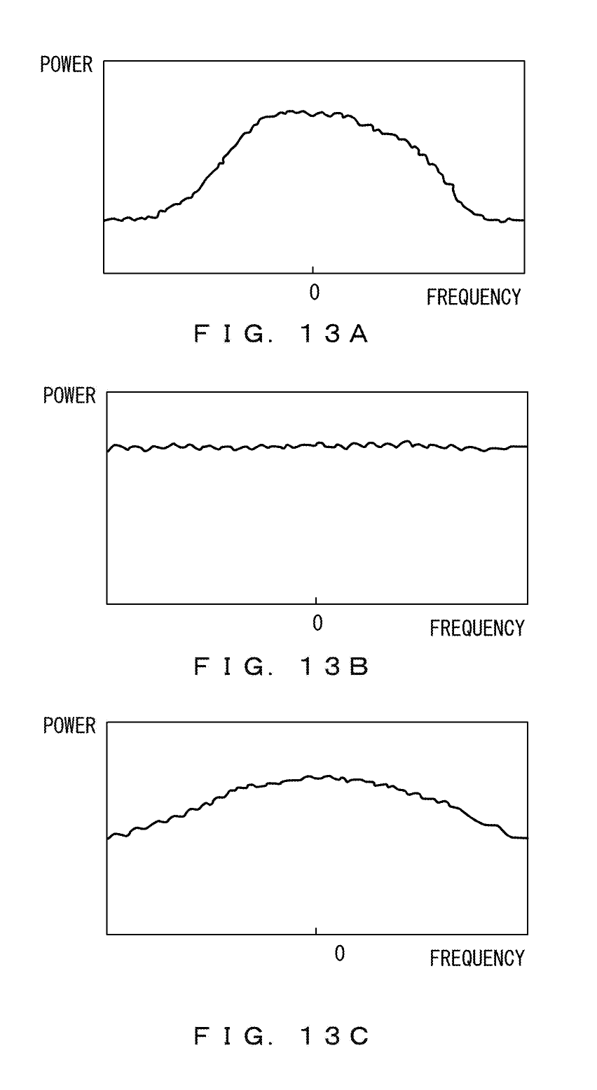

FIGS. 13A-13C illustrate an operation of the adaptive equalizer 34. A signal input to the adaptive equalizer 34 has been filtered by the digital filter 31, which operates as a low-pass filter. Therefore, as illustrated in FIG. 13A, the signal input to the adaptive equalizer 34 has a spectrum in which the power of low-frequency components is great and the power of high-frequency components is small.

FIG. 13B illustrates a spectrum of the signal which is equalized by the adaptive equalizer 34. The spectrum of the signal that is equalized by the adaptive equalizer 34 is substantially flat. In other words, the tap coefficients of the adaptive equalizer 34 are determined so that the spectrum of the output signal is substantially flat.

When the frequency characteristic of the digital filter 31 changes, the signal input to the adaptive equalizer 34 changes. Therefore, when the frequency characteristic of the digital filter 31 changes, the spectrum of the signal output from the adaptive equalizer 34 becomes temporality non-flat as illustrated in FIG. 13C.

Here, the tap coefficients of the adaptive equalizer 34 are controlled by a feedback system illustrated in FIG. 12. Therefore, if a certain convergence time has passed from when the signal input to the adaptive equalized 34 has changed, the spectrum of the signal output from the adaptive equalizer 34 is restored to the state illustrated in FIG. 13B. However, if the signal input to the adaptive equalizer 34 greatly changes due to a change in the frequency characteristic of the digital filter 31, a period of time taken for the feedback system of the adaptive equalizer 34 to converge becomes longer. Especially, in a configuration in which signal processing of a plurality of samples is performed in parallel, since more samples are processed by the time when the adaptive equalizer 34 has converged, the tracking performance of the adaptive equalizer 34 lowers. In addition, in a configuration in which step-size parameter μ is used in the coefficient calculators 34h and 34v, since the tap coefficients slowly change, the tracking performance of the adaptive equalizer 34 further lowers.

As described, if the tracking performance of the adaptive equalizer 34 is low, and when the signal input to the adaptive equalizer 34 greatly changes due to a change in the frequency characteristic of the digital filter 31, the adaptive equalizer 34 cannot appropriately equalize the spectrum of the signal. As a result, immediately after the frequency characteristic of the digital filter 31 changes, the characteristics of the signal are likely to deteriorate and the bit error rate is likely to be higher.

These problems are caused by a rapid change in the frequency characteristic of the digital filter which extracts the target channel. Therefore, the optical receiver circuit according to the embodiment of the present invention has a function for changing in stages the frequency characteristic of the digital filter that extracts the target channel. For example, when a target frequency characteristic is instructed, the optical receiver circuit 20 changes the frequency characteristic of the digital filter 31 from the present frequency characteristic to a target frequency characteristic in stages. By doing so, the phase adjusting amount is less likely to be deviated from the allowable range in the sampling phase detector 33. In addition, the spectrum of the signal output from the adaptive equalizer 34 may maintain a substantially flat state.

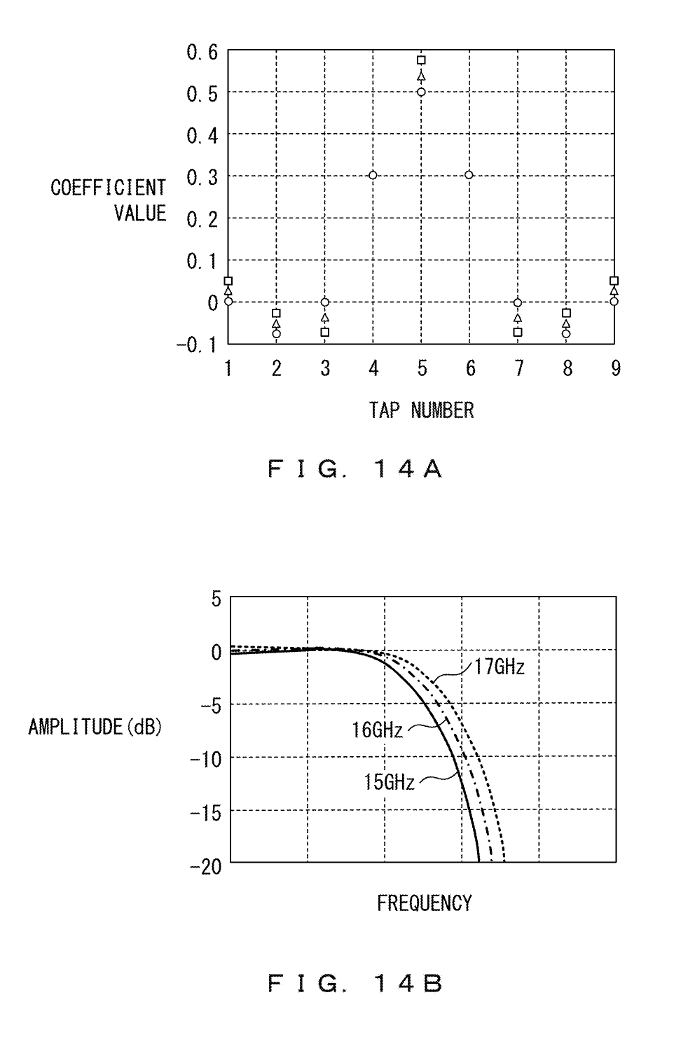

As an example, it is assumed that the digital filter 31 operates at a cutoff frequency of 15 GHz. At that time, tap coefficients for controlling the cutoff frequency to 15 GHz are given to the digital filter 31. For example, a tap coefficient set which is indicated by circle marks illustrated in FIG. 14A is given to the digital filter 31.

Here, it is assumed that a filter control instruction for changing the cutoff frequency from 15 GHz to 17 GHz is given to the optical receiver circuit 20. In this case, the optical receiver circuit 20 changes the cutoff frequency of the digital filter 31 from 15 GHz to 17 GHz in stages. In the example illustrated in FIG. 14B, the cutoff frequency is once changed from 15 GHz to 16 GHz, and then is changed to 17 GHz. In this case, a tap coefficient set for controlling the cutoff frequency to 16 GHz is given to the digital filter 31. Then, a tap coefficient set for controlling the cutoff frequency to 17 GHz is given to the digital filter 31. Note that in FIG. 14A, triangle marks indicate a tap coefficient set for controlling the cutoff frequency to 16 GHz, and square marks indicate a tap coefficient set for controlling the cutoff frequency to 17 GHz.

As described, the optical receiver circuit according to the embodiment of the present invention uses intermediate coefficients when changing the tap coefficients of the digital filter 31 from the present tap coefficients (hereinafter present coefficients) to tap coefficients for realizing the target cutoff frequency (hereinafter target coefficients). That is, the tap coefficients of the digital filter 31 are updated a plurality of times in the course of changing from the present coefficients to the target coefficients. At that time, the tap coefficients are updated so that the cutoff frequency of the digital filter 31 changes by a specified amount. In the following description, the change amount of the cutoff frequency of the digital filter 31 may be referred to as a “frequency change amount”. In addition, the tap coefficients are updated, for example, at specified time intervals. In the following description, the time interval for changing the tap coefficients may be referred to as an “update interval”.

In order to shorten the period of time taken for changing the tap coefficients of the digital filter 31 from the present coefficients to the target coefficients, the frequency change amount is increased and the update interval is shortened. However, in a case in which the frequency change amount is too great or the update interval is too short, the signal characteristics may deteriorate. Therefore, the frequency change amount and the update interval may be determined in consideration of the following conditions.

It is preferable that the frequency change amount be determined according to the tracking performance of the digital signal processor 24 with respect to a change in the cutoff frequency of the digital filter 31. For example, the frequency change amount is determined so that the phase adjusting amount of the sampling phase detector 33 does not deviate from the allowable range illustrated in FIG. 11B when the cutoff frequency of the digital filter 31 is changed. Alternatively, the frequency change amount may be determined so that the shape of the spectrum of the signal output from the adaptive equalizer 34 does not change greatly from the flat state when the cutoff frequency of the digital filter 31 is changed.

It is preferable that the update interval be determined according to the convergence time of the processing of the digital signal processor 24 with respect to a change in the cutoff frequency of the digital filter 31. For example, the update interval is determined so as to be longer than the convergence time of the sampling phase detector 33. The convergence time of the sampling phase detector 33 may be equivalent to a time from when the phase adjusting amount of the sampling phase detector 33 is changed due to a change in the cutoff frequency of the digital filter 31 until when the phase adjusting amount is returned to a value within a threshold range. Alternatively, the update interval may be determined so as to be longer than the convergence time of the adaptive equalizer 34. The convergence time of the adaptive equalizer 34 may be equivalent to a time from when the shape of the spectrum of the signal output from the adaptive equalizer 34 changes from the flat state due to a change in the cutoff frequency of the digital filter 31 until when the shape of the spectrum has restored to flat or nearly flat.

### First Embodiment

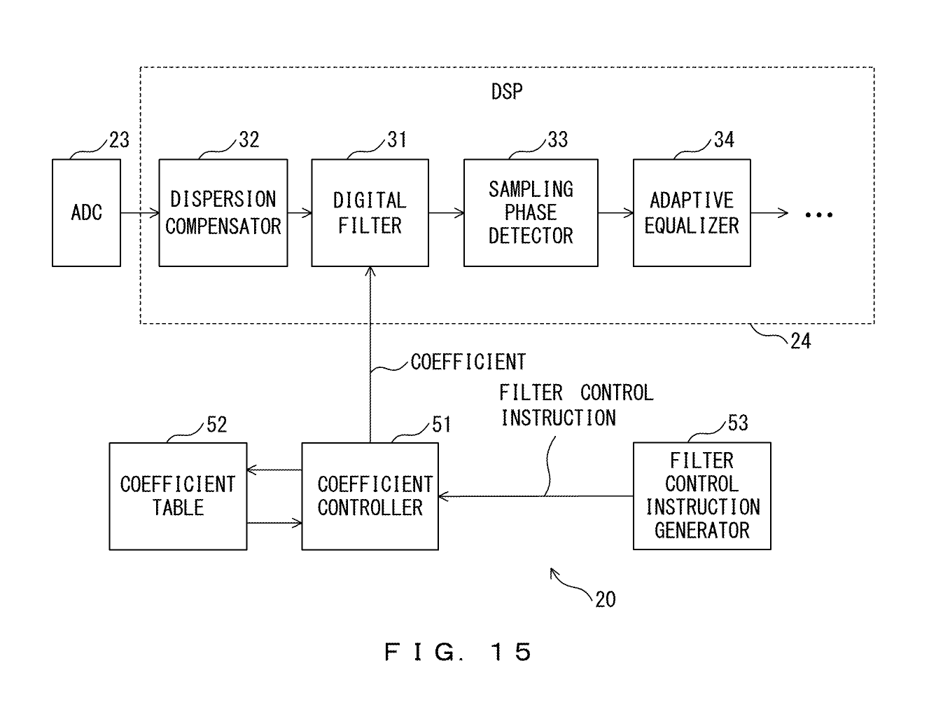

FIG. 15 illustrates an example of an optical receiver circuit according to a first embodiment. The optical receiver circuit 20 according to the first embodiment includes the A/D converter 23, the digital signal processor 24, a coefficient controller 51, and a coefficient table 52. The digital signal processor 24 provides the dispersion compensator 32, the digital filter 31, the sampling phase detector 33, and the adaptive equalizer 34.

Note that in FIG. 15, the receiver front-end circuit 21 and the local oscillation light source 22, which are provided on the input side of the A/D converter 23, are omitted. In addition, the digital signal processor 24 may provide the frequency offset compensator 35 and the carrier phase recovery 36 illustrated in FIGS. 7A and 7B. Furthermore, the optical receiver circuit 20 may include other circuit elements or functions which are not illustrated in FIG. 15.

The coefficient controller 51 updates the tap coefficients that are given to the digital filter 31 according to a filter control instruction. The filter control instruction specifies the cutoff frequency after change (hereinafter a target cutoff frequency) when a need arises to change the cutoff frequency of the digital filter 31. In addition, in this example, the filter control instruction is generated by a filter control instruction generator 53. For example, when a message indicating that the spacing between the target channel and the adjacent channel changes is given to the optical receiver circuit 20 from a transmitter station or the network management system, the filter control instruction generator 53 generates a filter control instruction which indicates the target cutoff frequency according to the message. Note that the target cutoff frequency may be calculated, for example, according to the spacing between the target channel and the adjacent channel.

The coefficient controller 51 holds information (or an index value which will be described later) indicating the present cutoff frequency of the digital filter 31 (hereinafter the present cutoff frequency). Then, the coefficient controller 51 accesses the coefficient table 52 according to the present cutoff frequency and the target cutoff frequency which is specified by the filter control instruction.

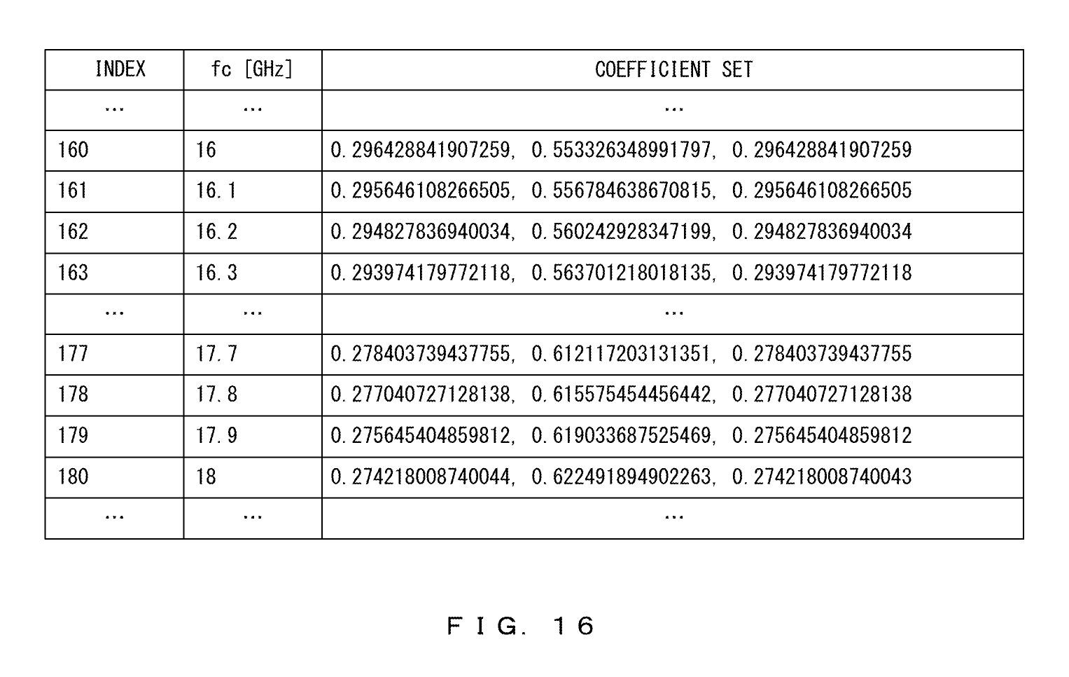

FIG. 16 illustrates an example of the coefficient table 52. In the coefficient table 52, tap coefficients for realizing a cutoff frequency of the digital filter 31 are stored for each cutoff frequency. In the example illustrated in FIG. 16, three tap coefficients are stored for each cutoff frequency; however, in reality, coefficients corresponding to each tap of the digital filter 31 are stored. That is, when the number of taps of the digital filter 31 is k, k tap coefficients are stored for each cutoff frequency.

The range of the cutoff frequencies for which tap coefficients are stored in the coefficient table 52 is, for example, from zero to the baud rate of the received optical signal. Alternatively, when the A/D converter 23 performs double sampling, the range of the cutoff frequencies for which tap coefficients are stored in the coefficient table 52 may be from zero to the half of the sampling frequency. In addition, tap coefficients are stored in the coefficient table 52 at specified frequency spacing. In the example illustrated in FIG. 16, tap coefficients are stored in the coefficient table 52 at 0.1 GHz spacing. The frequency spacing is equivalent to the above “frequency change amount”. Note that the coefficient table 52 is prepared in advance according to measurement, simulation, etc. In addition, each record in the coefficient table 52 is referred to using the index value.

When receiving the filter control instruction, the coefficient controller 51 accesses the coefficient table 52 and obtaines tap coefficients. Then, the coefficient controller 51 gives the obtained tap coefficients to the digital filter 31. Therefore, the frequency characteristic of the digital filter 31 may be controlled according to the filter control instruction. That is, the cutoff frequency of the digital filter 31, which operates as a low-pass filter, may be controlled according to the filter control instruction.

The coefficient controller 51 is implemented, for example, by firmware which is installed in the optical receiver circuit 20. In this case, the firmware may be executed by a processor other than the digital signal processor 24. In addition, the coefficient controller 51 may be implemented by the digital signal processor 24.

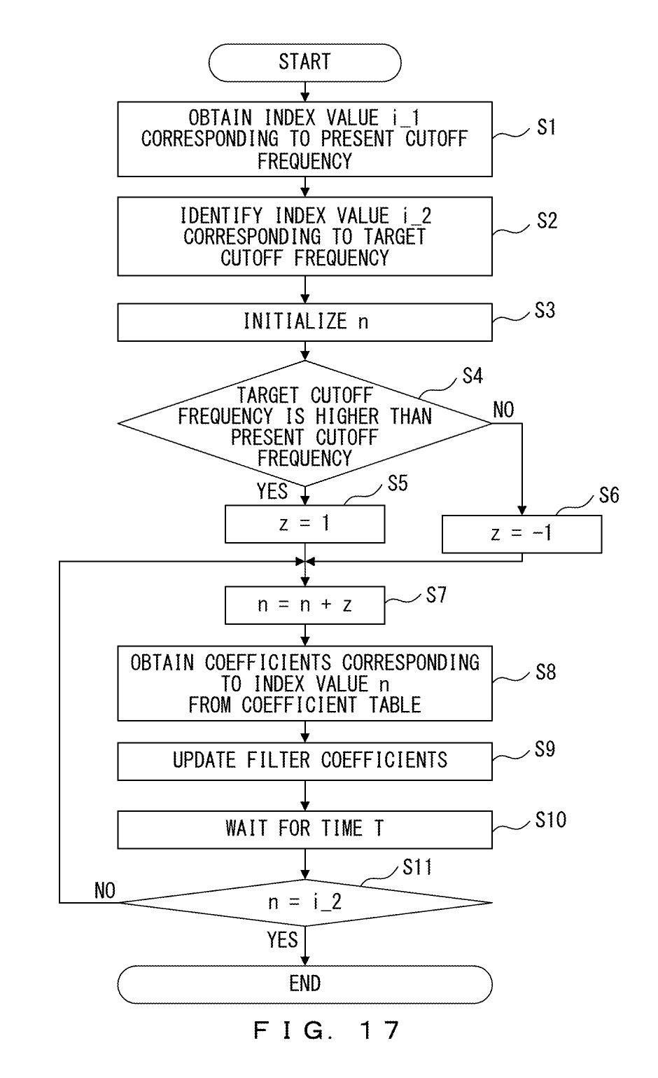

FIG. 17 is a flowchart illustrating an example of the tap coefficient updating method according to the first embodiment. The processes in the flowchart are executed, for example, when a filter control instruction is given to the coefficient controller 51. In addition, it is assumed that the filter control instruction specifies the target value of the cutoff frequency (hereinafter the target cutoff frequency) of the digital filter 31.

In S1, the coefficient controller 51 obtains index value i_1 corresponding to the present cutoff frequency (here the cutoff frequency of the digital filter 31 when a filter control instruction is given to the coefficient controller 51). Note that index value i_1 corresponding to the present cutoff frequency is recorded in a memory which can be accessed by the coefficient controller 51.

In S2, the coefficient controller 51 identifies index value i_2 corresponding to the target cutoff frequency which is specified by the filter control instruction. Note that it is assumed that in the coefficient table 52, the index value and the cutoff frequency uniquely correspond to each other, and the coefficient controller 51 can identify the index value corresponding to the specified target cutoff frequency.

In S3, the coefficient controller 51 initializes variable n. Variable n counts the index value. In addition, the initial value of variable n is index value i_1 corresponding to the present cutoff frequency.

In S4, the coefficient controller 51 compares the present cutoff frequency with the target cutoff frequency. When the target cutoff frequency is higher than the present cutoff frequency, the coefficient controller 51 sets variable z to “1” in S5. In contrast, when the target cutoff frequency is lower than the present cutoff frequency, the coefficient controller 51 sets variable z to “−1” in S6. Variable z indicates whether to increase or decrease the index value in the repetition process in S7-S11.

In S7, the coefficient controller 51 adds variable z to variable n. That is, the index value is incremented or decremented. Specifically, when the target cutoff frequency is higher than the present cutoff frequency, the index value is incremented by 1. In contrast, when the target cutoff frequency is lower than the present cutoff frequency, the index value is decremented by 1.

In S8, the coefficient controller 51 obtains tap coefficients corresponding to index value n from the coefficient table 52. Index value n is represented by variable n which has been updated in S7. In S9, the coefficient controller 51 gives to the digital filter 31 the tap coefficients that are obtained from the coefficient table 52. That is, the coefficient controller 51 updates the tap coefficients of the digital filter 31 using the tap coefficients that are obtained in S8. Then, the digital filter 31 performs filtering using the updated tap coefficients.

In S10, the coefficient controller 51 waits for time T from when the tap coefficients of the digital filter 31 have been updated. Time T is determined in advance according to the convergence time of the digital signal processor 24. For example, time T is determined according to the convergence time of the sampling phase detector 33 or the adaptive equalizer 34 with respect to the change amount of the cutoff frequency of the digital filter 31.

In S11, the coefficient controller 51 decides whether variable n has reached index value i_2. Here, index value i_2 indicates the record corresponding to the target cutoff frequency. Therefore, whether or not the cutoff frequency of the digital filter 31 has changed to the target cutoff frequency is decided. When variable n has not reached index value i_2, the processing of the coefficient controller 51 returns to S7. That is, the coefficient controller 51 repeats the processes in S7-S10 until variable n has reached index value i_2. When variable n has reached index value i_2, the processing of the coefficient controller 51 is terminated.

For example, it is assumed that when the filter control instruction is given to the optical receiver circuit 20, the cutoff frequency of the digital filter 31 is 16 GHz. In addition, it is assumed that the filter control instruction specifies the target cutoff frequency as 18 GHz. Furthermore, the optical receiver circuit 20 includes the coefficient table 52 illustrated in FIG. 16. In this case, index value i_1 corresponding to the present cutoff frequency is “160”. In addition, index value i_2 corresponding to the target cutoff frequency is “180”.

The processes of the flowchart illustrated in FIG. 17 are started under the above conditions. Here, the initial value of variable n is “160”. In addition, since the target cutoff value is higher than the present cutoff frequency, “z=1” is obtained in S4-S6. Therefore, in S7, variable n is incremented from “160” to “161”. Then, in S8-S9, the coefficient controller 51 obtains tap coefficients corresponding to index value “161” from the coefficient table 52 and gives them to the digital filter 31. By this operation, the cutoff frequency of the digital filter 31 is updated from 16 GHz to 16.1 GHz.

When time T has elapsed from when the tap coefficients have been updated as described, the process in S11 is executed. Here, variable n is “161” and is less than index value i_2. Therefore, the processing of the coefficient controller 51 returns to S7.

The coefficient controller 51 repeats the processes in S7-S10 until variable n has reached index value i_2. For each of the processing of S7-S10, variable n is incremented by 1 and the tap coefficients of the digital filter 31 are updated. By this operation, the cutoff frequency of the digital filter 31 increases in stages by 0.1 GHz. When the cutoff frequency of the digital filter 31 has changed to 18 GHz, variable n has reached index valuei_2. Therefore, the processing of the coefficient controller 51 is terminated.

As described, in the first embodiment, the tap coefficients of the digital filter 31 are updated at fixed time intervals T, and the cutoff frequency is shifted in stages from the present cutoff frequency to the target cutoff frequency. At that time, the change amount of the cutoff frequency in one updating operation is determined according to the tracking performance of the sampling phase detector 33 and/or the adaptive equalizer 34. In addition, the time interval of coefficient updating is determined according to the convergence time of the sampling phase detector 33 and/or the adaptive equalizer 34. Therefore, when the frequency characteristic of the digital filter 31 is changed according to a change in spacing between the target channel and the adjacent channel, deterioration in characteristics due to signal processing that is executed on the output side of the digital filter 31 is small. That is, according to the embodiment of the present invention, deterioration in quality of the received signal is small with respect to a change in arrangement in a wavelength division multiplexed optical signal.

### Second Embodiment

As described, when the tap coefficients of the digital filter 31 are updated, signal characteristics temporarily deteriorate. Then, after the convergence time of phase detection and/or adaptive equalization has elapsed, the signal characteristics are restored to a good state. Therefore, in the first embodiment, the convergence time of phase detection and/or adaptive equalization is determined in advance according to measurement, simulation, etc., and time interval T is determined according to the convergence time. Then, the tap coefficients are repeatedly updated at time interval T.

In a second embodiment, the operation state of the sampling phase detector 33 or the adaptive equalizer 34 is monitored. Then, the tap coefficients of the digital filter 31 are updated according to the monitoring result.

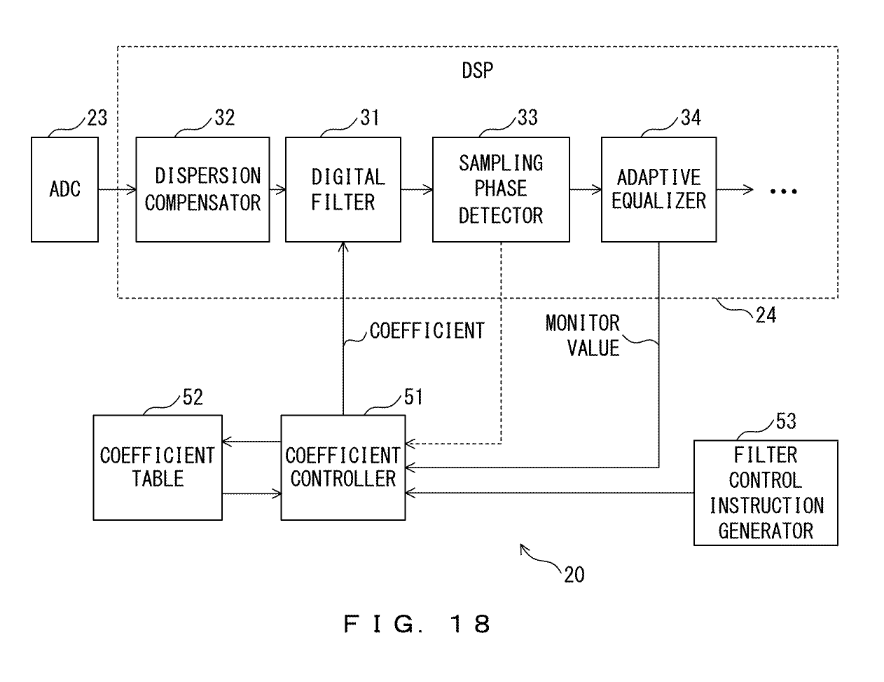

FIG. 18 illustrates an example of the optical receiver circuit according to the second embodiment. Here, the configuration of the optical receiver circuit 20 in the second embodiment is substantially the same as the configuration in the first embodiment. However, in the second embodiment, the convergence states of the sampling phase detector 33 and/or the adaptive equalizer 34 are monitored and the coefficient controller 51 executes the updating process of the tap coefficients according to the monitoring result.

For example, the adaptive equalizer 34 monitors distortion of the shape of the spectrum of the output signal. Here, as described with reference to FIG. 12 and FIGS. 13A-13C, the adaptive equalizer 34 equalizes the input signal so that the spectrum of the output signal becomes flat. That is, when an equalization operation has sufficiently converged, the spectrum of the signal output from the adaptive equalizer 34 is substantially flat as illustrated in FIG. 13B. However, immediately after the tap coefficients of the digital filter 31 are updated, the shape of the spectrum of the signal output from the adaptive equalizer 34 is temporality distorted as illustrated in FIG. 13C.

Therefore, the adaptive equalizer 34 generates a monitor value which indicates the difference between an optimal spectrum and the present spectrum. It is assumed that the optimal spectrum is the state illustrated, for example, in FIG. 13B and is known. In this case, immediately after the tap coefficients of the digital filter 31 are updated, the monitor value temporarily becomes great. Then, since the spectrum of the signal output from the adaptive equalizer 34 gradually becomes closer to the optimal spectrum due to feedback control, the monitor value gradually becomes smaller. Therefore, when the monitor value is sufficiently small, the equalization operation of the adaptive equalizer 34 is decided to be sufficiently converged. Note that the difference between the optimal spectrum and the present spectrum may be calculated according to the target coefficients that are generated by the coefficient calculators 34h and 34v illustrated in FIG. 12.

The coefficient controller 51 updates the tap coefficients of the digital filter 31 using the monitor value. As an example, when the monitor value is greater than a specified threshold, the coefficient controller 51 does not update the tap coefficients. Therefore, accumulation of equalization errors in the adaptive equalizer 34 is avoided.

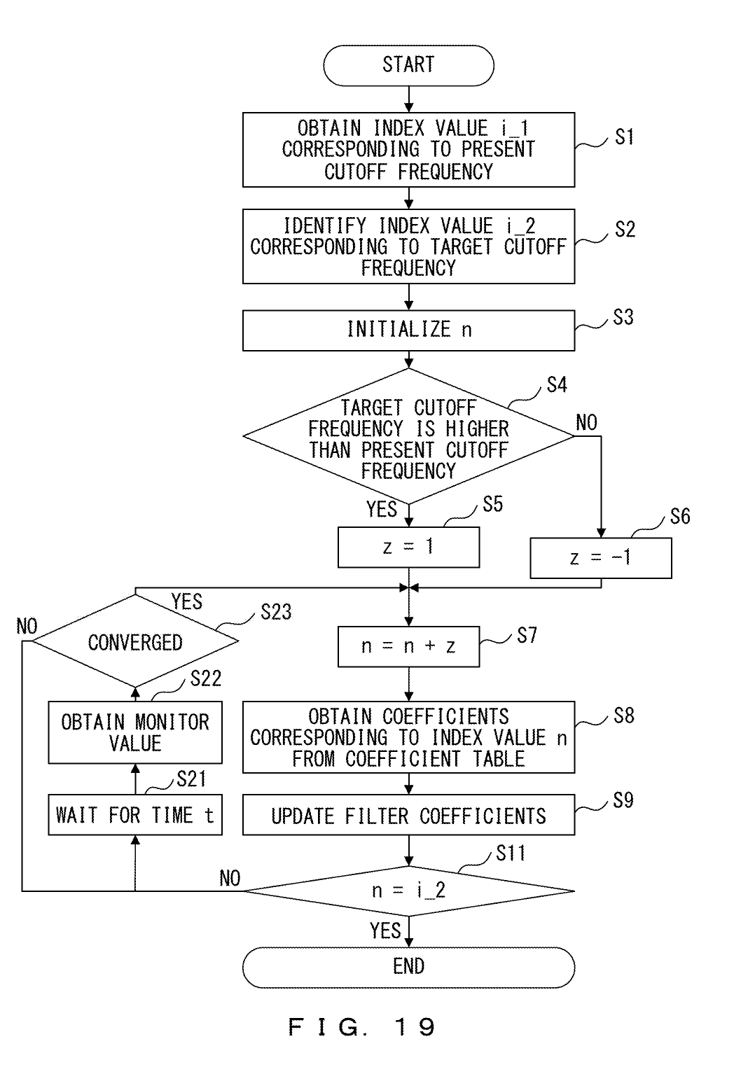

FIG. 19 is a flowchart illustrating an example of the tap coefficient updating method according to the second embodiment. Note that the processes in S1-S9 in the second embodiment is substantially the same as the processes in S1-S9 in the first embodiment. Therefore, differencies between the first embodiment and the second embodiment will be described below.

After updating the tap coefficients of the digital filter 31 in S9, the coefficient controller 51 decides in S11 whether variable n has reached index value i_2. When variable n has not reached index value i_2, the coefficient controller 51 executes the processes in S21-S23.

In S21, the coefficient controller 51 waits for time t from when the tap coefficients of the digital filter 31 have been updated. It is assumed that time t is shorter than time T in the first embodiment. Then, when time t has elapsed, the coefficient controller 51 obtains a monitor value from the adaptive equalizer 34 in S22. As described, the monitor value indicates the difference between the optimal spectrum of the signal output from the adaptive equalizer 34 and the present spectrum of the signal.

In S23, the coefficient controller 51 compares the obtained monitor value with a specified threshold. The threshold indicates a state in which the difference between the optimal spectrum of the signal output from the adaptive equalizer 34 and the present spectrum of the signal is sufficiently small. Therefore, when the monitor value is greater than the threshold, the coefficient controller 51 decides that the equalization operation of the adaptive equalizer 34 has not converged. In this case, the processing of the coefficient controller 51 returns to S21. That is, the processes in S21-S23 are repeated until the monitor value becomes less than or equal to the threshold. Note that it takes time t for executing the processes in S21-S23 one time. Then, when the monitor value becomes less than or equal to the threshold, the processing of the coefficient controller 51 moves to S7.

The coefficient controller 51 repeats the processes in S7-S9 (including S21-S23) until variable n has reached index value i_2. When variable n has reached index value i_2, the processing of the coefficient controller 51 is terminated.

As described, after updating the tap coefficients in the processes in S8-S9, the coefficient controller 51 monitors the spectrum of the signal output from the adaptive equalizer 34 using the monitor value. Then, when the monitor value becomes less than or equal to the threshold, next coefficient updating operation is executed. That is, when the spectrum of the signal output from the adaptive equalizer 34 becomes substantially flat, next coefficient updating operation is executed.

In the second embodiment, when the equalization operation of the adaptive equalizer 34 converges after the tap coefficients have been updated, next coefficient updating operation is executed without waiting for time T used in the first embodiment. Therefore, it is possible to make the time taken for changing the cutoff frequency of the digital filter 31 in the optical receiver circuit according to the second embodiment shorter than the time in the first embodiment.

Note that in the above example, the operation state of the adaptive equalizer 34 is monitored; however, the embodiments of the present invention are not limited to this configuration. That is, the coefficient controller 51 may determine the coefficient updating timing using a monitor value which indicates the operation state of the sampling phase detector 33. In this case, the sampling phase adjusting amount that is calculated by the loop filter 33b illustrated in FIGS. 11A and 11B or a sampling frequency controlling value which is calculated by the loop filter 33d is used as the monitor value. Furthermore, the coefficient controller 51 may determine the coefficient updating timing using a monitor value which indicates another operation of the digital signal processor 24.

### Third Embodiment

In the first and second embodiments, the change amount of the cutoff frequency of the digital filter 31 is fixed. In contrast, in the third embodiment, while the state of phase detection and/or adaptive equalization is monitored, the change amount of the cutoff frequency is adjusted according to a monitor value obtained by monitoring the state. Note that the monitor value in the third embodiment may be the same as the monitor value in the second embodiment. Therefore, the configuration of the optical receiver circuit 20 in the third embodiment is substantially the same as the configuration in the second embodiment.

However, it is preferable that the coefficient table be prepared at narrower frequency spacing in the third embodiment than in the first and second embodiments. That is, in the example illustrated in FIG. 16, the tap coefficients are stored at 0.1 GHz spacing; however, in the third embodiment, the tap coefficients are stored, for example, at 10 MHz spacing.

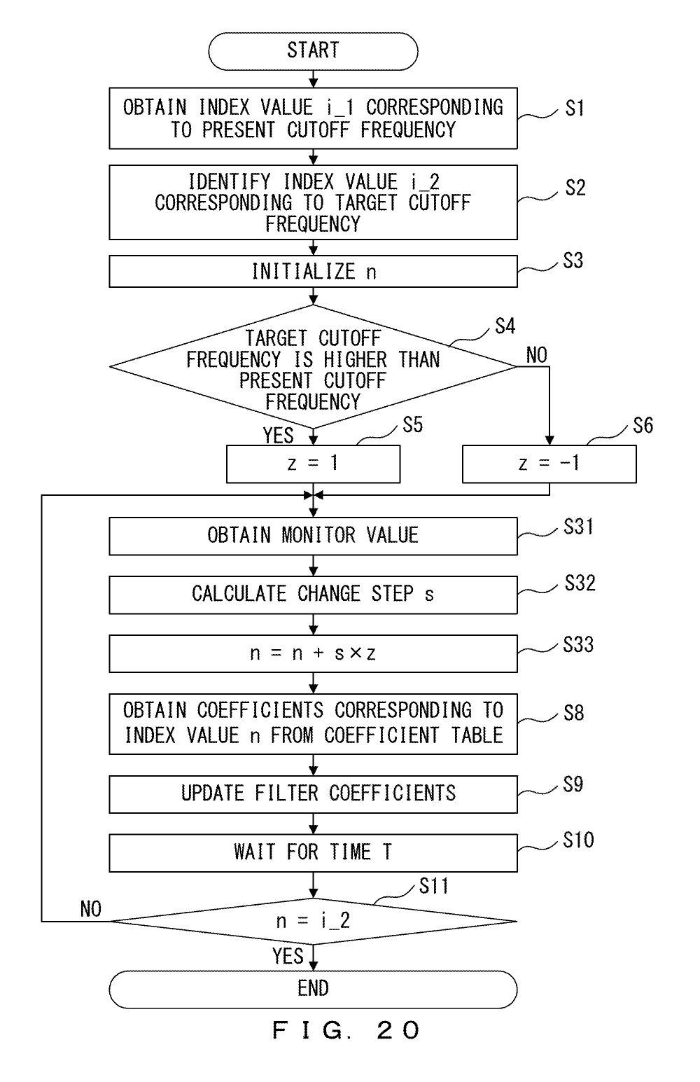

FIG. 20 is a flowchart illustrating an example of the tap coefficient updating method according to the third embodiment. Note that the processes in S1-S6 and S8-S11 are substantially the same in the first embodiment and the third embodiment. Therefore, difference between the first embodiment and the third embodiment will be described below.

In the third embodiment, the coefficient controller 51 executes the processes in S31-S33 in place of the process in S7 illustrated in FIG. 17. That is, in S31, the coefficient controller 51 obtains a monitor value from the adaptive equalizer 34. As described, the monitor value indicates the difference between the optimal spectrum of the signal output from the adaptive equalizer 34 and the present spectrum of the signal.

In S32, the coefficient controller 51 calculates change step s according to the obtained monitor value. At that time, as the monitor value is greater, smaller change step s is calculated, and as the monitor value is smaller, greater change step s is calculated. As an example, the coefficient controller 51 calculates the difference between the obtained monitor value and a specified upper limit value. The upper limit value is determined so as to represent the allowable maximum bit error rate of data that is recovered from the received signal. Alternatively, the upper limit value is designed so that a frame out-of-synchronization does not occur.

Then, the coefficient controller 51 calculates change step s, for example, using the following formula.

S=round(|upper limit value−monitor value|)

“round” represents a function for rounding the value in parenthesis. That is, change step s is calculated by rounding the absolute value of the difference between the upper limit value and the monitor value. Note that in the example, change step s is a positive integer.

In S33, the coefficient controller 51 shifts the index value of the coefficient table 52 by s. The shift direction is specified by variable z. For example, it is assumed that the change amount of the coefficient table 52 is 10 MHz, the upper limit value is 10, and the monitor value is 4.2. In this case, change step s is 6. Therefore, the coefficient controller 51 shifts the index value by 6. By this operation, the cutoff frequency of the digital filter 31 shifts by 60 MHz.

As described, in the third embodiment, the change amount of the cutoff frequency of the digital filter 31 is determined for each coefficient updating operation according to the monitor value indicating the state of the signal output from the adaptive equalizer 34. Therefore, it is possible to surely make the bit error rate of recovered data smaller than a specified threshold when the tap coefficients of the digital filter 31 are updated.

Note that in the above example, the operation state of the adaptive equalizer 34 is monitored; however, the embodiments of the present invention are not limited to this configuration. That is, the coefficient controller 51 may determine the change amount of the cutoff frequency using a monitor value indicating the operation state of the sampling phase detector 33. Furthermore, the coefficient controller 51 may determine the change amount of the cutoff frequency using a monitor value indicating another operation of the digital signal processor 24.

### Other Embodiments

In the above example, the coefficient controller 51 controls the state of the digital filter 31 according to an instruction that is given from the transmitter station, the network management system, etc. However, the embodiments of the present invention are not limited to this configuration. That is, the optical receiver circuit 20 may control the state of the digital filter 31 without receiving an instruction from outside.

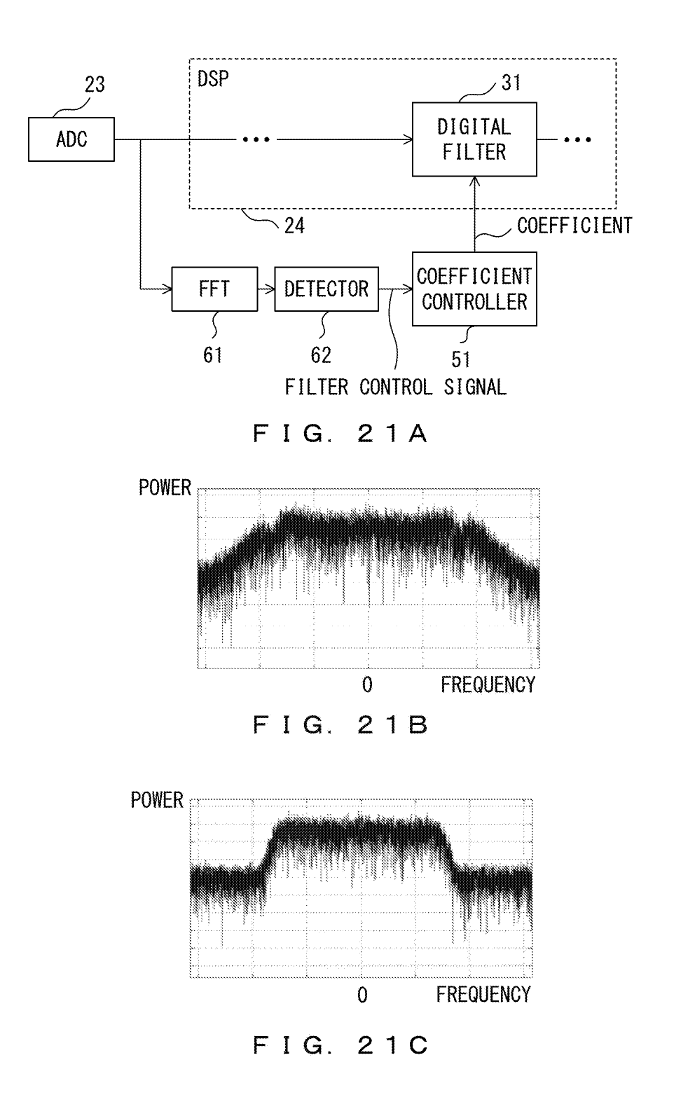

For example, as illustrated in FIG. 21A, the optical receiver circuit 20 includes an FFT circuit 61 and a detector 62. The FFT circuit 61 executes FFT computation for a digital signal output from the A/D converter 23 and generates a frequency domain signal. The detector 62 detects the spectrum of the target channel and the frequency region around the target channel according to the frequency domain signal generated by the FFT circuit 61. That is, the detector 62 detects the target channel and its adjacent channel. Then, the detector 62 generates a filter control instruction according to the spacing between the target channel and the adjacent channel.

FIGS. 21B and 21C illustrate the spectrums of the received signal (frequency domain signal generated by the FFT circuit 61). In the example illustrated in FIG. 21B, an adjacent channel is detected in the vicinity of the target channel. In this case, the detector 62 measures the spacing between the target channel and the adjacent channel according to the detected spectrum and determines the cutoff frequency of the digital filter 31 according to the measurement result. Then, the detector 62 gives a filter control instruction which specifies the determined cutoff frequency to the coefficient controller 51. By doing so, the coefficient controller 51 updates the tap coefficients of the digital filter 31 according to the filter control instruction.

In contrast, in the example illustrated in FIG. 21C, no adjacent channels are detected in the vicinity of the target channel. In this case, the detector 62 gives to the coefficient controller 51 a filter control instruction indicating that the adjacent channel does not transmit a signal. Then, the coefficient controller 51 updates the tap coefficients so that the digital filter 31 has a sufficiently wide passband. Alternatively, the coefficient controller 51 may stop the digital filter 31.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical receiver that receives wavelength division multiplexed light including a target channel, the optical receiver comprising:
a receiver configured to generate an electric signal from input light that includes the target channel;
an A/D (Analog-to-Digital) converter configured to convert the electric signal generated by the receiver into a digital signal;
a digital filter configured to filter the digital signal output from the A/D converter with a first frequency characteristic; and
a filter controller configured to control a frequency characteristic of the digital filter, wherein
the filter controller changes the frequency characteristic of the digital filter from the first frequency characteristic to a second frequency characteristic in stages when a filter control instruction that specifies the second frequency characteristic is given to the filter controller.

2. The optical receiver according to claim 1, wherein
the filter controller updates tap coefficients of the digital filter in stages so that a cutoff frequency of the digital filter changes from a first frequency to a second frequency via at least one intermediate frequency.

3. The optical receiver according to claim 2, wherein
the filter controller updates the tap coefficients of the digital filter in stages so that the cutoff frequency of the digital filter changes from the first frequency to the second frequency in stages with a specified frequency change amount.

4. The optical receiver according to claim 3, wherein
the filter controller updates the tap coefficients of the digital filter in stages at specified time intervals.

5. The optical receiver according to claim 2, further comprising
an equalizer configured to equalize a signal output from the digital filter, wherein
in a process of repeatedly updating the tap coefficients so that the cutoff frequency of the digital filter changes in stages with a specified amount, the filter controller
monitors a spectrum of a signal output from the equalizer after the tap coefficients have been updated, and
updates the tap coefficients when the spectrum becomes substantially flat.

6. The optical receiver according to claim 2, further comprising
a sampling phase detector configured to detect a sampling phase of the A/D converter and determine a phase adjusting amount for adjusting the sampling phase based on a signal output from the digital filter, wherein
in a process of repeatedly updating the tap coefficients so that the cutoff frequency of the digital filter changes with a specified amount, the filter controller
monitors the phase adjusting amount determined by the sampling phase detector after the tap coefficients have been updated, and
updates the tap coefficients when the phase adjusting amount becomes less than a specified threshold.

7. The optical receiver according to claim 2, further comprising
an equalizer configured to equalize a signal output from the digital filter, wherein
in a process of repeatedly updating the tap coefficients so that the cutoff frequency of the digital filter changes at a specified time interval, the filter controller
monitors a spectrum of a signal output from the equalizer at a time point when a period of time corresponding to the specified time interval has elapsed from when the tap coefficients have been updated,
calculates a change amount of the cutoff frequency of the digital filter according to a shape of the monitored spectrum, and
updates the tap coefficients so that the cutoff frequency of the digital filter changes by the calculated change amount.

8. The optical receiver according to claim 2, further comprising
a sampling phase detector configured to detect a sampling phase of the A/D converter and determine a phase adjusting amount for adjusting the sampling phase based on a signal output from the digital filter, wherein
in a process of repeatedly updating the tap coefficients so that the cutoff frequency of the digital filter changes at a specified time interval, the filter controller
monitors the phase adjusting amount determined by the sampling phase detector at a time point when a period of time corresponding to the specified time interval has elapsed from when the tap coefficients have been updated,
calculates a change amount of the cutoff frequency of the digital filter according to the phase adjusting amount, and
updates the tap coefficients so that the cutoff frequency of the digital filter changes by the calculated change amount.

9. The optical receiver according to claim 1, further comprising
a detector configured to detect the target channel and an adjacent channel according to a digital signal output from the A/D converter and generate the filter control instruction according to a spacing between the target channel and the adjacent channel, wherein
the filter controller controls the frequency characteristic of the digital filter according to the filter control instruction generated by the detector.

10. A method for updating tap coefficients of a digital filter in an optical receiver circuit including:
a receiver configured to receive wavelength division multiplexed light that includes a target channel and generate an electric signal from the wavelength division multiplexed light;
an A/D (Analog-to-Digital) converter configured to convert the electric signal that is generated by the receiver into a digital signal; and
a digital filter configured to filter the digital signal output from the A/D converter, the method comprising:
receiving a filter control instruction that specifies a second frequency characteristic when the digital filter filters the digital signal with a first frequency characteristic; and
updating the tap coefficients of the digital filter in stages so that a frequency characteristic of the digital filter changes from the first frequency characteristic to the second frequency characteristic.
